(19) United States
(12) Patent Application Publication
(10) Pub. No.: US 2023/0334365 A1
(43) Pub. Date: Oct. 19, 2023

(54) FEATURE ENGINEERING AND ANALYTICS SYSTEMS AND METHODS

(71) Applicant: ExlService Holdings, Inc., New York, NY (US)

(72) Inventors: Rahul Nawab, Ahmedabad (IN); Deepti Kalra, Jersey City, NJ (US); Anushree Seth, Greater Noida (IN); David Morgan, Phoenix, AZ (US)

(21) Appl. No.: 18/134,385

(22) Filed: Apr. 13, 2023

Related U.S. Application Data
(60) Provisional application No. 63/330,712, filed on Apr. 13, 2022.

(51) Int. Cl. G06N 20/00; G06F 16/215; G06F 16/2458

(52) U.S. Cl. CPC G06N 20/00; G06F 16/215; G06F 16/2468

(57) ABSTRACT

A feature engineering engine is included in an analytics application provided to at least one subscriber from a plurality of subscribers. The feature engineering engine generates a reduced discovery dataset based on an input dataset and stores at least a portion of the reduced discovery dataset in cache memory associated with the analytics application. While displaying at least a portion of the reduced discovery dataset, the feature engineering engine performs one or more entity resolution operations and generates an instantiated set of features. In some embodiments, the instantiated set of features is generated based on a previously generated, reusable feature definition. In some embodiments, using the instantiated set of features, a trained machine learning model is automatically selected from a plurality of models based on a performance metric determined for the instantiated set of features.

### CROSS-REFERENCE TO RELATED APPLICATION(S)

This application claims the benefit of U.S. Provisional Pat. Application No. 63/330,712, filed Apr. 13, 2022, titled FEATURE ENGINEERING AND ANALYTICS SYSTEMS AND METHODS, which is hereby incorporated by reference in its entirety.

### TECHNICAL FIELD

The present disclosure relates generally to systems, methods and computer-readable media for artificial intelligence/machine learning (AI/ML) based analytics. More particularly, the present disclosure relates to systems, methods, and computer-readable media for feature engineering in AI/ML model development.

### BACKGROUND

In AI/ML, computers can be trained to solve a particular problem and/or perform a specific task by identifying patterns in input data. AI/ML models can use data from multiple sources to generate computer-based predictions. Input data can be sourced from different operational systems, which can have different underlying data encoding schemas. For example, a first operational system can store customer data in normalized form, where a customer data store is separate from a customer transaction data store, and a second operational data system can store customer data as part of customer transaction data, which may result in duplicates when customer transaction data in the second operational system is queried for customer data. Differences in data encoding schemas make multi-input AI/ML models prone to errors and difficult to apply across cases. Even when single-source input data is used with an AI/ML model, noise, outliers, and unexpected values in input data can reduce the accuracy of the output.

### BRIEF DESCRIPTION OF THE DRAWINGS

FIG. 1 is a block diagram showing an analytics platform in accordance with some implementations of the present technology.

FIG. 2 is a flowchart showing example operations of the analytics platform in accordance with some implementations of the present technology.

FIG. 3A is a block diagram showing example components of a graphical user interface (GUI) in the analytics platform, in accordance with some implementations of the present technology.

FIGS. 3B-3E are block diagrams showing example GUIs for the data acquisition and feature engineering engines of the analytics platform in accordance with some implementations of the present technology.

FIGS. 4A-4D are diagrams showing example model explainability GUIs of the feature engineering engine of the analytics platform in accordance with some implementations of the present technology.

FIGS. 4E-4H are diagrams showing example GUIs for the AI/ML modeling engine of the analytics platform in accordance with some implementations of the present technology.

FIGS. 5A and 5B are diagrams illustrating example use cases of the analytics platform in accordance with some implementations of the present technology.

FIG. 6 is a block diagram showing some of the components typically incorporated in at least some of the computer systems and other devices on which the disclosed system operates in accordance with some implementations of the present technology.

FIG. 7 is a system diagram illustrating an example of a computing environment in which the disclosed system operates in some implementations of the present technology.

The drawings have not necessarily been drawn to scale. For example, the relative sizes of signaling periods in the figures are not to scale, and the size of certain signaling or messaging periods may differ. Similarly, some components and/or operations may be separated into different blocks or combined into a single block for the purposes of discussion of some of the embodiments of the disclosed system. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents and alternatives falling within the scope of the technology as defined by the appended claims.

### DETAILED DESCRIPTION

Data scientists seek to answer complex questions using input data. For example, questions related to customer data can include: “Which products is Customer B likely to purchase?” or “Why do our customers leave?” Question related to IoT (internet-of-things) device performance can include: “How can IoT devices of type N be optimized to conserve electricity?” and so forth. To enable data scientists to answer these questions using various types of input data, including operational data, the inventors have conceived and reduced to practice systems, methods, and computer-readable media for feature engineering in AI/ML model development.

As disclosed herein, feature engineering techniques improve the technical field of AI/ML model development by decoupling feature definitions from source datasets and projects. As a result, feature definitions, which can be thought of as input items transformed to be usable by AI/ML models, can be reused across projects. Furthermore, as disclosed herein, feature engineering techniques improve performance of AI/ML applications. AI/ML applications can include data connectors structured to access input data from source systems. Processing vast quantities of input data can create a performance bottleneck by increasing latency of AI/ML applications. For instance, a data scientist may have to wait while an AI/ML application accesses and loads the source data. To solve these problems, the techniques disclosed herein introduce improved dataset processing techniques for generating and operating on reduced exploratory datasets during feature engineering. Furthermore, using feature engineering to cross-reference existing feature definitions can reduce the number of read/write operations (e.g., across a communications network between the source system and the AI/ML analytics platform) at the point the data is ingested by the platform.

As used herein, the term “AI/ML model” refers to computer-executable code and/or configuration file(s) structured to execute operations to perform data analytics and/or to generate computer-based recommendations, scores, trends, predictions, and the like. AI/ML models described herein can receive various inputs, which can be transformed using feature engineering techniques described herein. As used herein, the term “feature” refers to a transformed unit relating to an input data item, where a particular unit can represent a singular data item, a segment of a data item, a combination of data items, a combination of segments of data items, an aggregation (summary) of values in a data item across multiple records, and/or a synthetic (derived) item based on one or more of the above. The term “data” refers broadly to binary, numerical, alphanumeric, alphabetic, text, image, video, audio data, or a combination thereof. The term “instantiated feature” refers to a feature definition populated with data.

### Analytics Platform

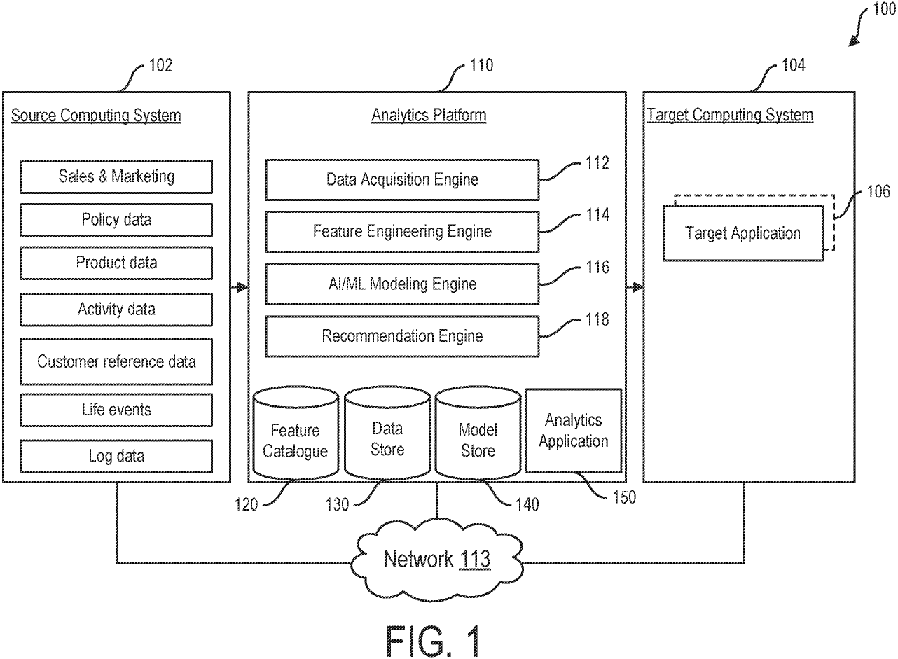

FIG. 1 is a block diagram showing an example analytics platform 110 in a computing environment 100 in accordance with some implementations of the present technology. As a general overview, to overcome technical limitations of existing systems and techniques, the inventors have conceived and reduced to practice systems, methods, and computer-readable media for feature engineering in AI/ML model development. To that end, the analytics platform 110 allows for increased speed and ease of deploying AI/ML analytics solutions. To achieve these technical advantages, the analytics platform 110 decouples data architecture for input datasets from feature data architecture, which increases project cross-portability of feature definitions. For example, a particular feature definition can be used with multiple, different data sources across different system implementations. Furthermore, the analytics platform 110 increases model reusability by supporting a library of AI/ML models. In some implementations, the AI/ML models can be pre-configured based on particular features. Further still, the analytics platform 110 increases explainability of model outputs by enabling feature versioning and providing single-screen interfaces that visualize how the features impact predictions.

As shown, the analytics platform 110 can be communicatively coupled, via a communications network 113, to one or more source computing systems 102 and/or one or more target computing systems 104. In some implementations, the analytics platform 110 is provided in a cloud-based environment, such as, for example, in a virtual private cloud, via a virtual network, in a SaaS (software-as-a-service computing environment), PaaS (platform-as-a-service computing environment), DaaS (data-as-a-service computing environment) and/or the like. In some implementations, the analytics platform 110 can include an application instance (e.g., analytics application 150) made available to subscriber entities that operate one or more target computing systems 104. In some implementations, the application instance is made available to internal users within an entity that provides, hosts, and/or administers the analytics platform 110. For brevity, the terms “user” and “subscriber” are used interchangeably, although one of skill will appreciate the implementations of the present technology are not limited to subscription-based implementations.

The analytics platform 110 can receive (e.g., access, retrieve, ingest), through a suitable communications interface, various data items from the source computing system 102. For example, the source computing system 102 can generate or provide data regarding an entity’s operations in one or more knowledge domains, such as sales, marketing, insurance policy, healthcare operations, product analytics, activity analytics, customer interaction analytics, life event analytics, actuarial operations, internet-of-things (IoT) device operations, industrial/plant operations, and/or physical and/or virtual systems. To that end, the source computing system 102 can be or include an enterprise information system, an accounting system, a supply chain management system, an underwriting system, a payment processing system, a smart device (e.g., drone, autonomous vehicle, patient monitoring device, wearable), and/or another device capable of generating or providing input data for the analytics platform 110.

The data acquisition engine 112 is structured to allow the analytics platform 110 to ingest (enable a user to enter, import, acquire, query for) input data for use with AI/ML analytics. A particular source computing system 102 can provide input data via a suitable method, such as via a user interface (e.g., by providing a GUI in an application available to a subscriber entity that allows a subscriber to enter or upload data), via an application programming interface (API), by using a file transfer protocol (e.g., SFTP), by accessing an upload directory in the file system of the analytics platform 110, by accessing a storage infrastructure associated with the analytics platform 110 and configured to allow the source computing system 102 to execute write operations and save items, and the like. In some implementations, the storage infrastructure can include physical items, such as servers, direct-attached storage (DAS) devices, storage area networks (SANs) and the like. In some implementations, the storage infrastructure can be a virtualized storage infrastructure that can include object stores, file stores and the like. In some implementations, the ingestion engine can include event-driven programming components (e.g., one or more event listeners) that can coordinate the allocation of processing resources at runtime based on the size of the received input item submissions and/or other suitable parameters. The acquired data and other supporting data can be stored in data store 130 associated with the analytics platform 110.

The analytics platform 110 can be configured to ingest items from multiple source computing systems 102 associated with a particular subscriber entity. For example, a healthcare organization, acting as a subscriber, may wish to perform analytics on data generated by different systems, such as an electronic medical records (EMR) system, a pharmacy system, a lab information system (LIS), and the like. As another example, an insurance company, acting as a subscriber, may wish to perform analytics on data generated by different systems, such as agent calendars, underwriting systems, policy management systems, and the like. To ingest the data, the analytics platform 110 (e.g., the data acquisition engine 112) can include an API gateway, which can be structured to allow developers to create, publish, maintain, monitor, and secure different types of interface engines supported by different source computing systems 102. The interface engines can include, for example, REST interfaces, HTTP interfaces, WebSocket APIs, and/or the like.

In some implementations, the data acquisition engine 112 can enable a user (e.g., a data scientist) of the target computing system 104 to access a data acquisition GUI via the analytics application 150. The GUI can include controls to import a dataset from the source computing system 102, to browse for a dataset in memory associated with the target computing system 104 (e.g., where the user uploads the dataset), and/or to retrieve the dataset from the data store 130.

The input data ingested by the analytics platform 110 can include individually addressable structured data items, semi-structured data, and/or unstructured data in a format that is not capable of directly being processed by a machine learning model. The data can include tabular data, log data, calendar data, images, health records, insurance policy records, documents, books, journals, audio, video, metadata, analog data, and the like.

The feature engineering engine 114 is structured to enable feature management operations, such as creation of features based on the input data, feature storage, feature versioning, and so forth. In some implementations, the feature engineering engine works in conjunction with the feature catalogue 120. The feature catalogue 120 can be structured to store feature definitions (e.g., at least in part as YAML files or other suitable markup language files), which can include feature identifiers, feature configuration parameters, SQL queries associated with feature design (e.g., select statements, table joins, and so forth), feature versioning information, and so forth. Additionally or alternatively, the feature catalogue 120 can store pre-built features for various knowledge domains.

To enable portability of AI/ML solutions across projects and/or environments (e.g., across instances of the analytics platform 110), the feature engineering engine 114 can enable a user (e.g., data scientist) to access a particular feature definition in a feature catalogue 120 and map input data to the feature definition. One or more AI/ML models stored in the model store 140 can be pre-trained to use the particular feature definition to generate a recommendation, score, prediction, or the like. For example, a particular feature definition relating to healthcare revenue cycle analytics can include a variable for monthly charges. Some organizations may calculate monthly charges based on the number of patients seen and procedures performed in a particular month. Other organizations may calculate monthly charges based on the amount billed in a particular month, even if the work was performed in prior reporting periods. The feature definition for monthly charges can allow for standardization of data given the different interpretations. To that end, the feature engineering engine can include a GUI (e.g., the analytics application 150) that provides data mapping controls to allow the user to map items in input datasets to particular feature definitions.

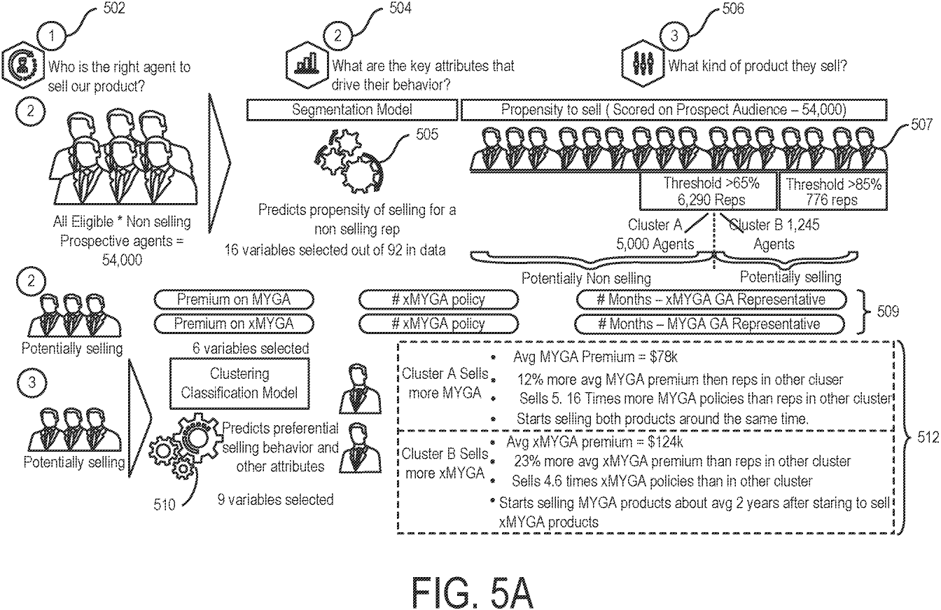

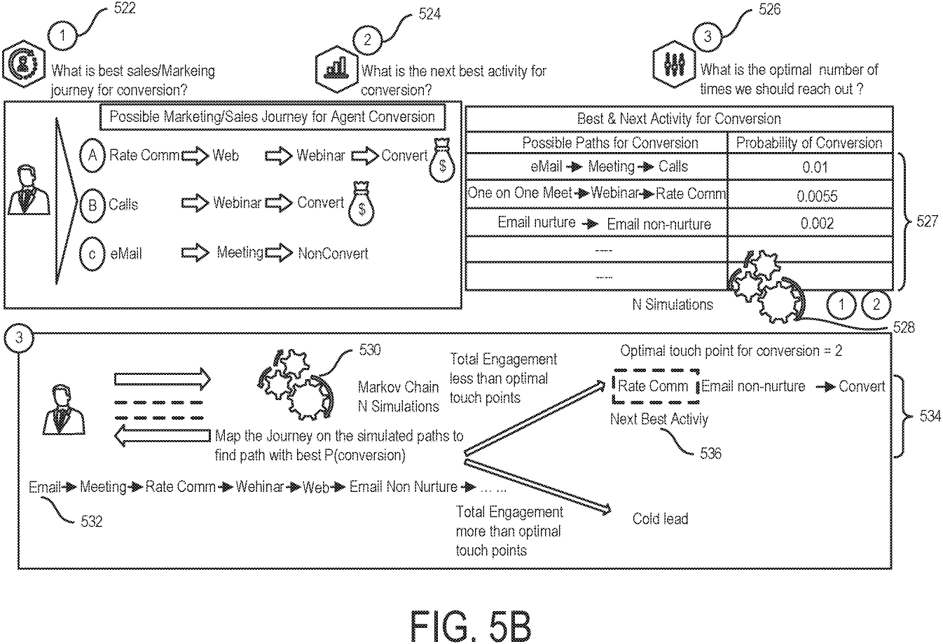

The AI/ML modeling engine 116 is structured to perform AI/ML analytics on the input data transformed according to feature engineering definitions using the analytics application 150. The machine learning models can be structured to perform any suitable artificial intelligence-based operations, such as those described with respect to the use cases of FIGS. 5A and 5B. Machine learning models can include one or more convolutional neural networks (CNN), deep learning (DL) models, translational models, natural language processing (NLP) models, computer vision-based models, or any other suitable models for enabling the operations described herein.

In some implementations, the machine learning models can include one or more neural networks. As an example, neural networks may be based on a large collection of neural units (or artificial neurons). Neural networks may loosely mimic the manner in which a biological brain works (e.g., via large clusters of biological neurons connected by axons). Each neural unit of a neural network can be connected with many other neural units of the neural network. Such connections can be enforcing or inhibitory in their effect on the activation state of connected neural units. In some implementations, each individual neural unit may have a summation function which combines the values of all its inputs together. In some embodiments, each connection (or the neural unit itself) may have a threshold function such that the signal must surpass the threshold before it propagates to other neural units. These neural network systems can be self-learning and trained, rather than explicitly programmed, and can perform significantly better in certain areas of problem solving, as compared to traditional computer programs. In some implementations, neural networks can include multiple layers (e.g., where a signal path traverses from front layers to back layers). In some implementations, back propagation techniques may be utilized by the neural networks, where forward stimulation is used to reset weights on the “front” neural units. In some implementations, stimulation and inhibition for neural networks may be more free-flowing, with connections interacting in a more chaotic and complex fashion.

As an example, machine learning models can ingest inputs and provide outputs. In one use case, outputs can be fed back to a machine learning model as inputs to train machine learning model (e.g., alone or in conjunction with user indications of the accuracy of outputs, labels associated with the inputs, or with other reference feedback information). In another use case, a machine learning model can update its configurations (e.g., weights, biases, or other parameters) based on its assessment of its prediction (e.g., outputs) and reference feedback information (e.g., user indication of accuracy, reference labels, or other information). In another use case, where a machine learning model is a neural network, connection weights can be adjusted to reconcile differences between the neural network’s prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this manner, for example, the machine learning model may be trained to generate better predictions.

As an example, where the prediction models include a neural network, the neural network can include one or more input layers, hidden layers, and output layers. The input and output layers can respectively include one or more nodes, and the hidden layers may each include a plurality of nodes. When an overall neural network includes multiple portions trained for different objectives, there may or may not be input layers or output layers between the different portions. The neural network can also include different input layers to receive various input data. Also, in differing examples, data can input to the input layer in various forms, and in various dimensional forms, input to respective nodes of the input layer of the neural network. In the neural network, nodes of layers other than the output layer are connected to nodes of a subsequent layer through links for transmitting output signals or information from the current layer to the subsequent layer, for example. The number of the links may correspond to the number of the nodes included in the subsequent layer. For example, in adjacent fully connected layers, each node of a current layer may have a respective link to each node of the subsequent layer, noting that in some examples such full connections may later be pruned or minimized during training or optimization. In a recurrent structure, a node of a layer may be again input to the same node or layer at a subsequent time, while in a bi-directional structure, forward and backward connections may be provided. The links are also referred to as connections or connection weights, referring to the hardware implemented connections or the corresponding “connection weights” provided by those connections of the neural network. During training and implementation, such connections and connection weights may be selectively implemented, removed, and varied to generate or obtain a resultant neural network that is thereby trained and that may be correspondingly implemented for the trained objective, such as for any of the above example recognition objectives.

The recommendation engine 118 can include or be included in the AI/ML modeling engine 116 and is structured to generate scores, probabilities, discovered clusters, data visualizations, indicators of trends, predictions, and other similar units of analysis based on the processing of transformed input data. In some implementations, the recommendation engine 118 can generate an electronic dashboard that displays the output of the AI/ML modeling engine 116. In some implementations, the recommendation engine 118 can include a user interface that allows the user (e.g., data scientist) to change, at runtime, threshold values for classification-based AI/ML models. In some implementations, the recommendation engine 118 can generate an electronic notification, such as an alert, which can be transmitted to a target computing device as an e-mail message, a pop-up message, a text message, a conversational entry in a chatbot agent, and so forth.

### Example Methods of Operation of the Analytics Platform

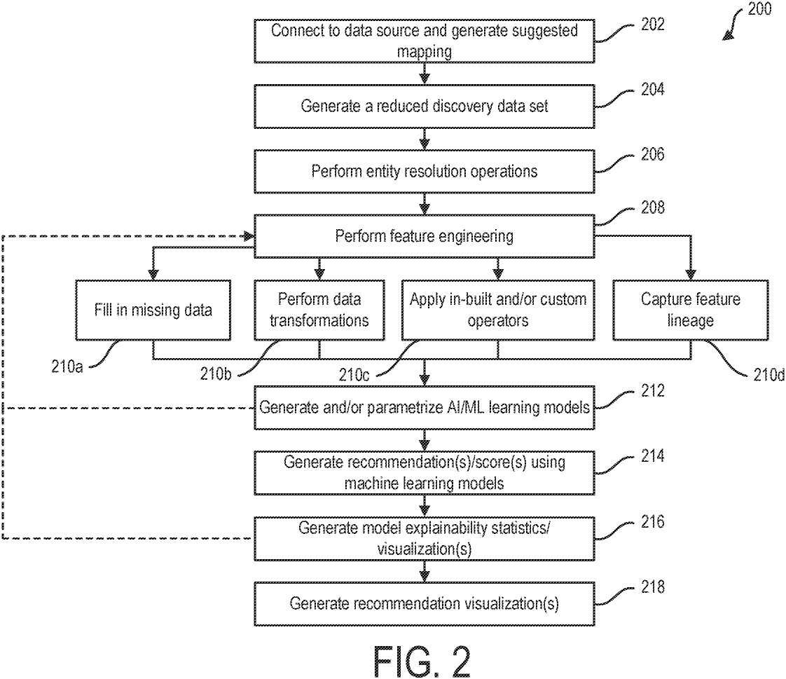

FIG. 2 is a flowchart showing example operations 200 of the analytics platform 110 in accordance with some implementations of the present technology. According to various implementations, operations 200 can be performed, in whole or in part, by or on the source computing system 102, analytics platform 110, target computing system 104 or another suitable computing system or device. One of skill will appreciate that operations 200 can be abbreviated, segmented, and/or combined as appropriate without departing from the spirit of the invention.

In operation of the analytics platform 110, at 202, the data acquisition engine 112 can connect to a data source (e.g., a source system, a data store, an interface, a Web socket) to acquire input data. In some implementations, the input data can be stored in cache memory associated with the analytics platform 110. In some implementations, the input data can be stored in one or more data stores 130 associated with the analytics platform 110.

The input data can correspond to feature definitions previously generated and stored in the feature catalogue 120. In such cases, the data acquisition engine 112 can generate and provide to the user (e.g., data scientist) a GUI structured to allow the user to map entities (e.g., table names) to entities within the feature catalogue 120. The data acquisition engine 112 can generate, at 204, a reduced discovery dataset to provide to the user a subset of data in a particular input dataset (e.g., table) to help the user determine or confirm the appropriate target feature definition. In some implementations, the reduced discovery dataset can be generated and stored in cache memory during the data importation process to bypass the need to query the data source as the user browses data, thereby reducing latency and improving performance of the analytics application 150.

The data acquisition engine 112 can generate, at 206, a GUI to allow the user to perform entity resolution operations--for example, by removing duplicates from input data. As an example, if a Customer dataset is generated using a Transaction dataset, customer identifiers can be duplicated in the input (Transaction) dataset because a particular customer can be associated with one or more transactions. The data acquisition engine 112 can detect such cases (using, for example, a reduced discovery dataset). In response to detecting a user-defined mapping from an input dataset to a feature definition in feature catalogue 120, the data acquisition engine 112 can check metadata associated with the feature definition to determine if duplicates are allowed (e.g., by referencing a flag, a SQL constraint and so forth) and perform an entity resolution check to determine if the input data field includes duplicates across records. In some implementations, the entity resolution check includes a comparison of entire stored values. In some implementations, the entity resolution check includes comparison of partial stored values using, for example, fuzzy matching to identify elements that exceed a similarity threshold. While performing fuzzy matching, the data acquisition engine 112 can compare two input strings and determine similarity scores (e.g., 1-10, 1-100, 1-000). In some implementations, similarity score thresholds can be set and/or adjusted, using the GUI, at runtime, as the data is imported. In some implementations, to perform entity resolution operations, the data acquisition engine 112 invokes the execution of a machine learning model (e.g., a fuzzy logic based model) stored in the model store 140.

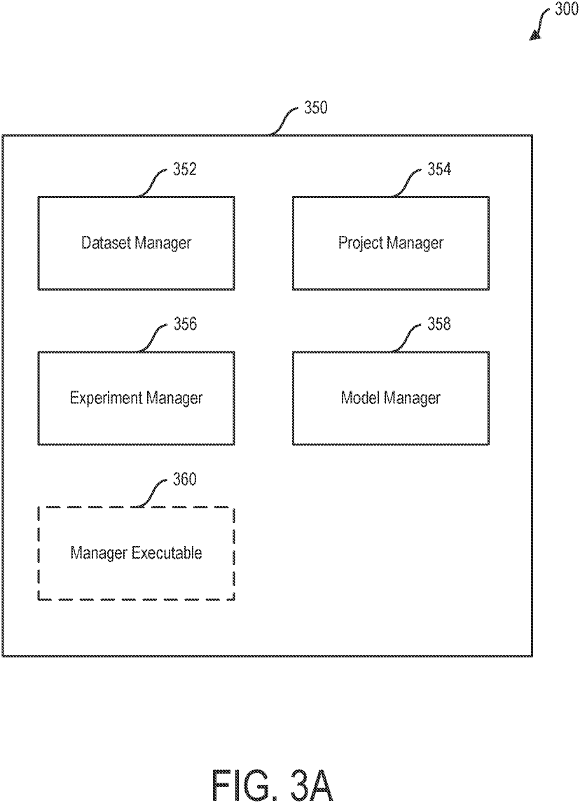

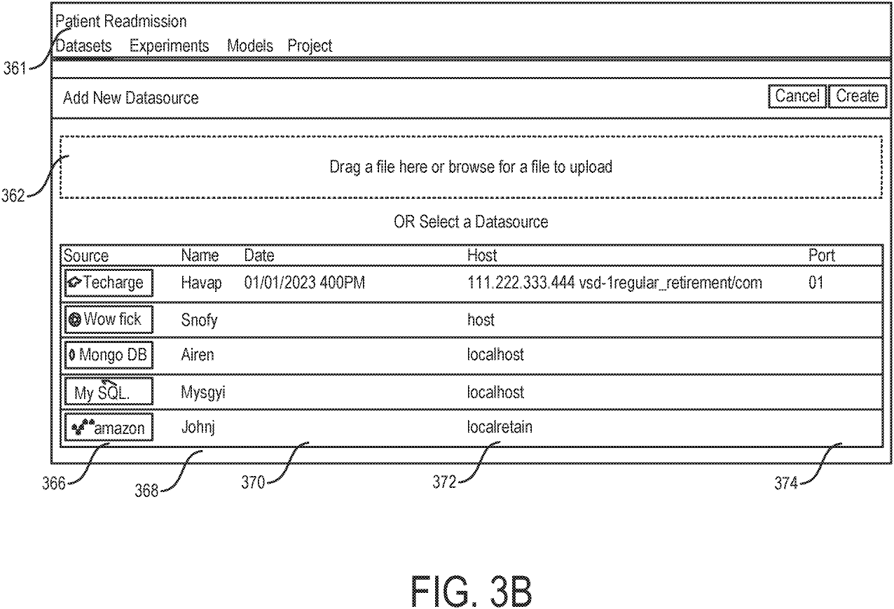

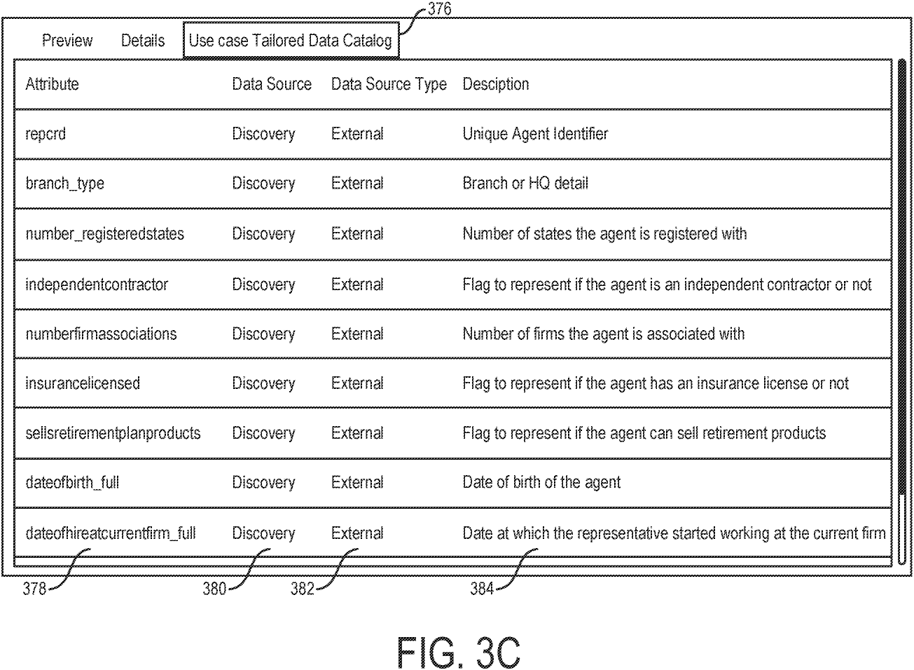

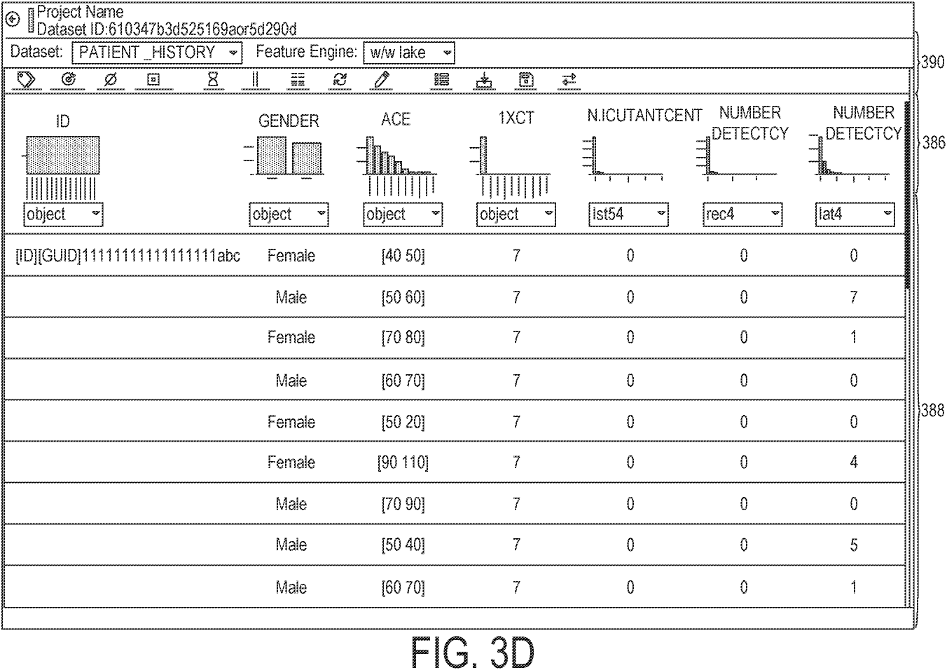

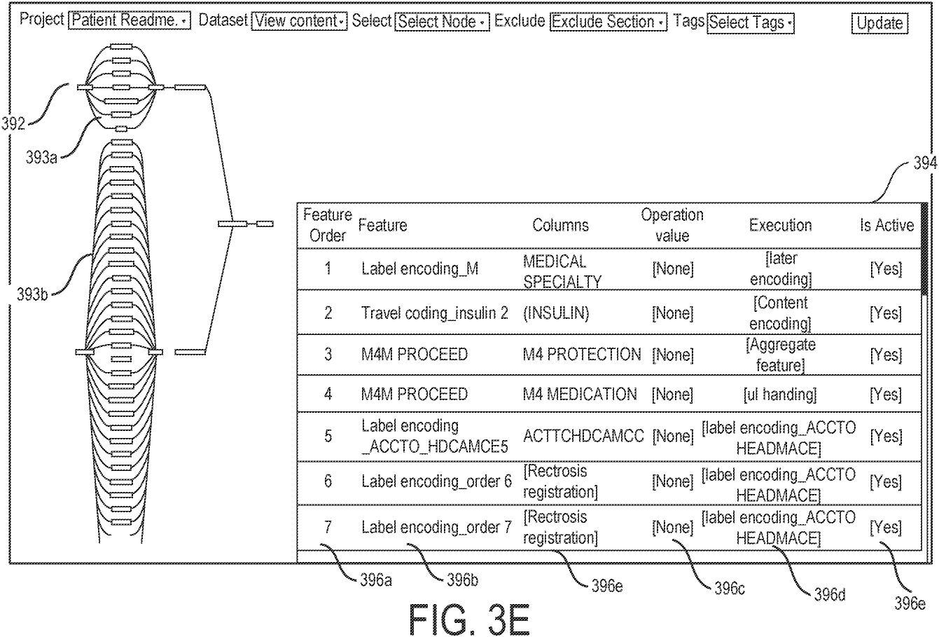

At 208, the feature engineering engine 114 can perform various feature engineering operations using input data as described further herein in relation to FIGS. 3C-3E. Generally, the feature engineering operations can include generating a new feature definition, updating a feature definition, and/or dropping (removing, deleting) a feature definition from the feature catalogue 120. Feature engineering operations can include the execution of one or more machine learning models stored in the model store 140.

In some implementations, user-guided feature engineering operations are performed on the exploratory dataset stored and processed in cache memory. For example, a user can review a system-generated recommendation to specify an imputation algorithm to use on the exploratory dataset representative of the full input dataset. To generate a representative reduced exploratory dataset, random sampling or stratified sampling can be used. Because of the reduced size of the exploratory/reduced discovery dataset, which can be limited to N records (e.g., 10, 100, 500, 1000), a percentage of records (1%, 5%, 10%) and/or a certain size (e.g., 10Kb, 100Kb, 1000Kb), the speed and performance of the analytics application 150 is improved. In some implementations, in order to reduce the size of the exploratory dataset to speed up feature engineering operations, the feature engineering engine 114 can pre-process the input data tables (e.g., execute operations to drop database indexes, perform data deduplication/entity resolution, and so forth). In some implementations, after user-guided operations are performed on the exploratory dataset, the feature engineering engine 114 can generate a summary statistics GUI, such as that of FIG. 3D, showing one or more graphical controls that include determined data values, groupings, clusters, graphs or other visualizations based on the performed user-guided feature engineering operations on the reduced dataset. After verifying that the outputs are acceptable, the user can cause the platform to perform the operations on the remainder of data in the input dataset.

In some implementations, feature engineering operations include executing 210a computer code to fill in missing data using imputation model(s), such as mean imputation, substitution, hot desk imputation, cold desk imputation, regression imputation, stochastic regression imputation, interpolation, and/or extrapolation. In some implementations, the feature engineering engine 114 can generate and display a GUI populated with recommended imputed values for a particular record in the input dataset. In some implementations, feature engineering operations include executing 210b computer code to perform data transformations on all or a subset of input data. Data transformation operations can include value concatenation, extraction of value segments, and so forth. In some implementations, feature engineering operations include executing 210c computer code to apply built-in and/or custom operators to all or a subset of input data. The operators can be comparison operators (“equal to”, “less than”, “greater than”), string parsing operators (“begins with”, “contains”), mathematical operators (“add”, “subtract”, “multiply”, “divide”), data type cast/conversion operators (“string()”, “date()”), or other suitable operators structured to transform input data to make it suitable for processing by the AI/ML modeling engine 116. As an example, a “total patient visits” feature can be defined differently for different healthcare organizations. In some instances, “total patient visits” can be determined by determining a number of unique patient encounters for a time period. In some instances, “total patient visits” can be determined by determining a number of total patient encounters for a time period where a patient may have had multiple visits. In some instances, “total patient visits” can be determined by determining a number of particular procedures performed in a time period. Accordingly, operators can be applied to specific input items in the input dataset (“visits”, “encounters”) to filter on specific values and/or summarize specific values (e.g., determine record counts or amount totals for records where the input items, such as “visits”, have specific values, such as “blood draw.”

In some implementations, feature engineering operations include executing 210d computer code to capture feature lineage and select a particular version of a feature definition from the lineage. For example, a particular feature definition can have different versions applicable to different instances of the analytics platform 110, different source computing systems 102, different target computing systems 104, different target applications 106, and so forth. For instance, a “total patient visits” feature can be defined differently for different product data sources on the source computing system 102 (e.g., lab system, primary care medical records, specialty department medical records), different data consumers (e.g., target systems or applications) and so forth.

The input data transformed according to the feature definitions can be used, at 212, as input to machine learning models in the model store 140. In some implementations, the machine learning models can be pre-trained using reference data. In some implementations, the machine learning models improve precision over time as higher quantities of input data are processed. In some implementations, a “base” model store 140 is globally accessible to multiple instances of the analytics platform 110, different source computing systems 102, different target computing systems 104, different target applications 106, and so forth, and different versions of specific models evolve as they are trained and executed on entity-specific input data.

The analytics platform 110 can generate recommendations and/or scores relating to the analyzed input data, at 214. In some implementations, the “base” model store 140 can include a “base” recommendation catalogue, which can include, for example, score definitions based on the “base” models. As the models are fine-tuned as they learn, the scoring algorithm definitions can be automatically updated. The recommendations and/or scores can be visualized in the form of graphs, dashboards, and so forth, at 216. In some implementations, alerts and/or notifications can be generated, and visualized, at 218, based on the recommendations and/or scores.

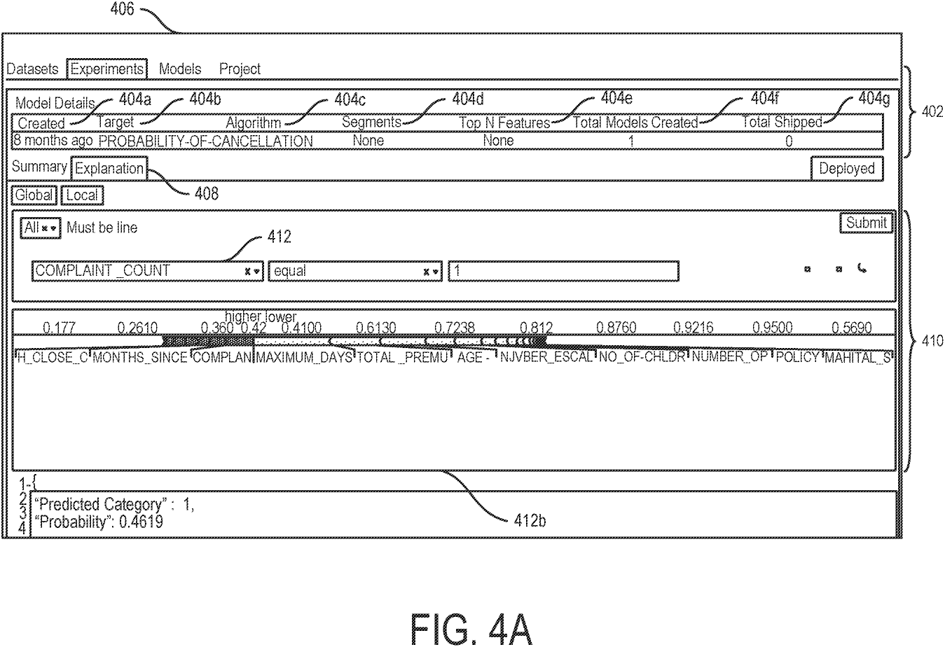

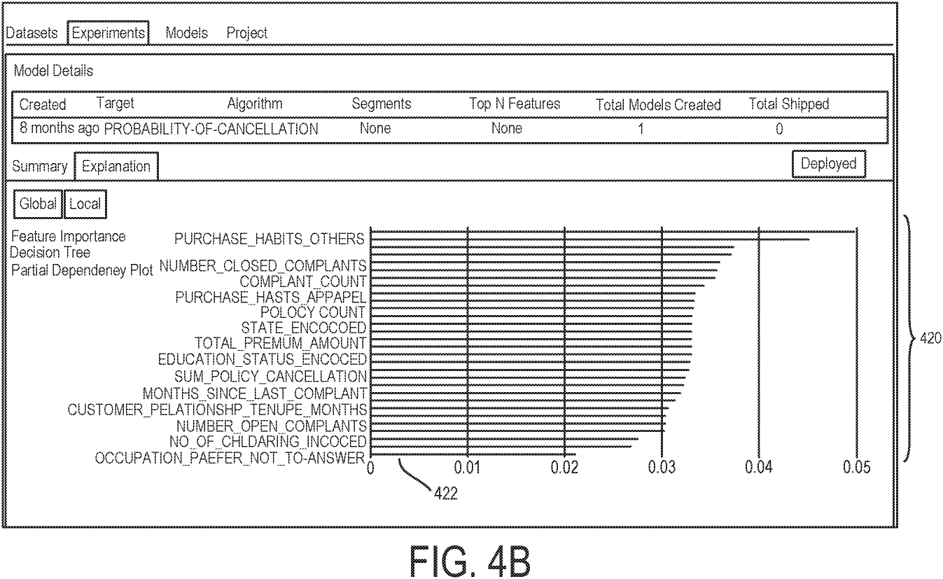

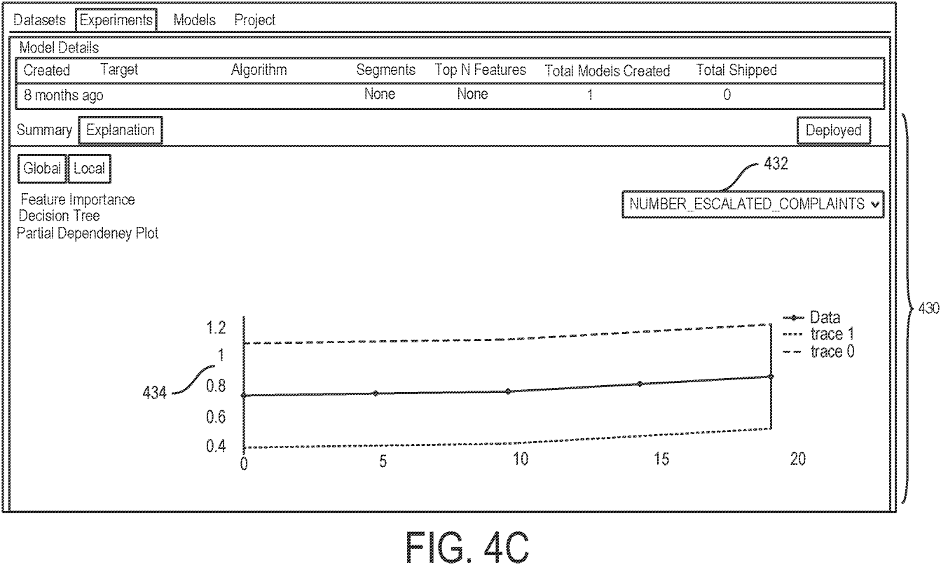

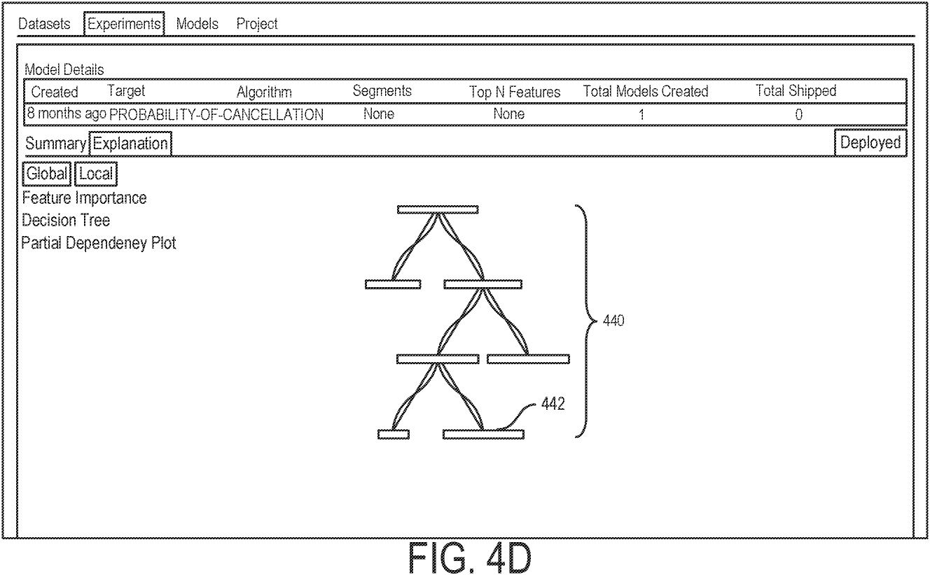

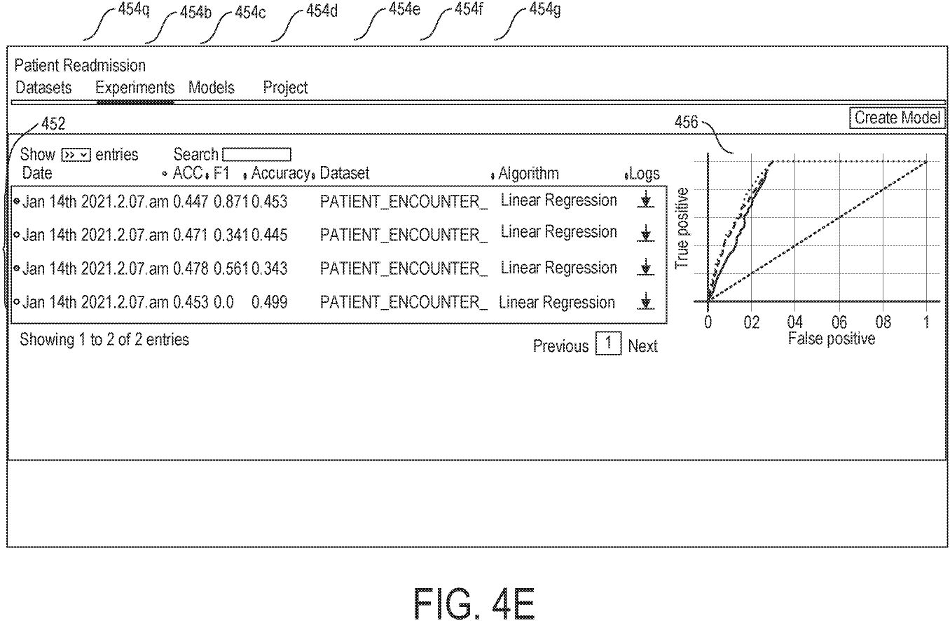

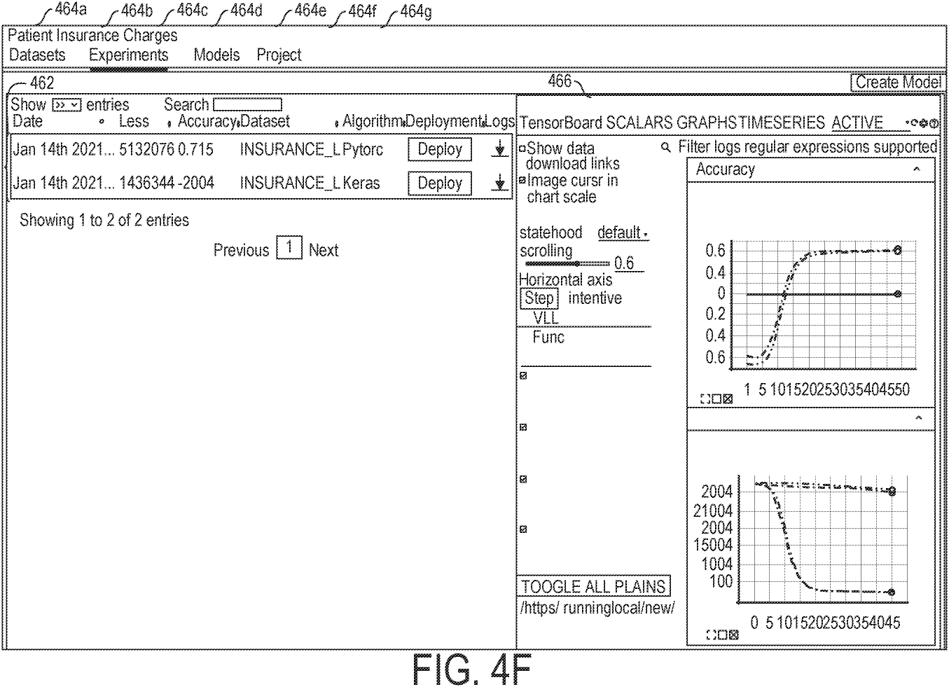

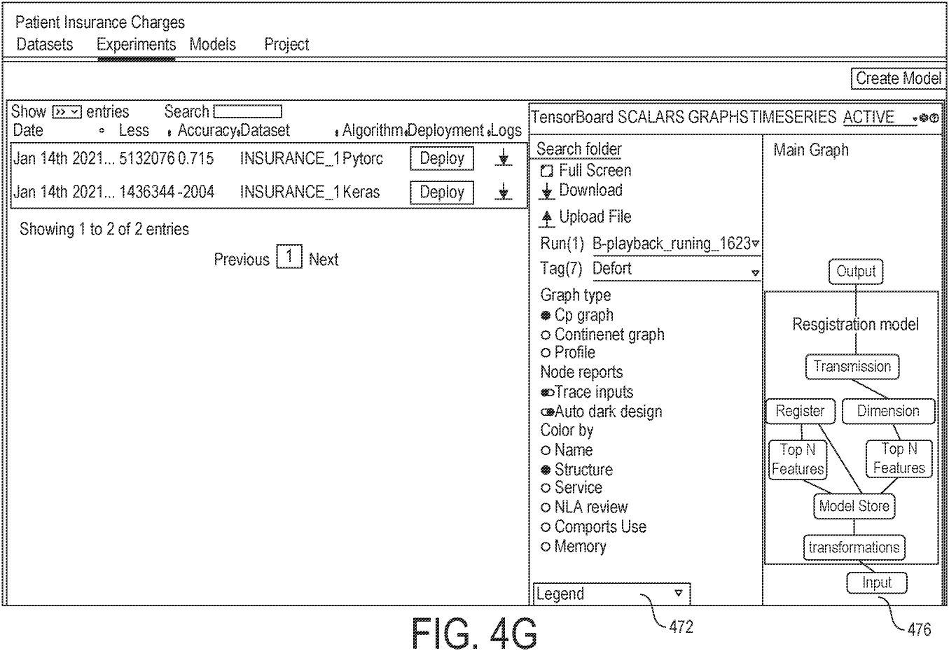

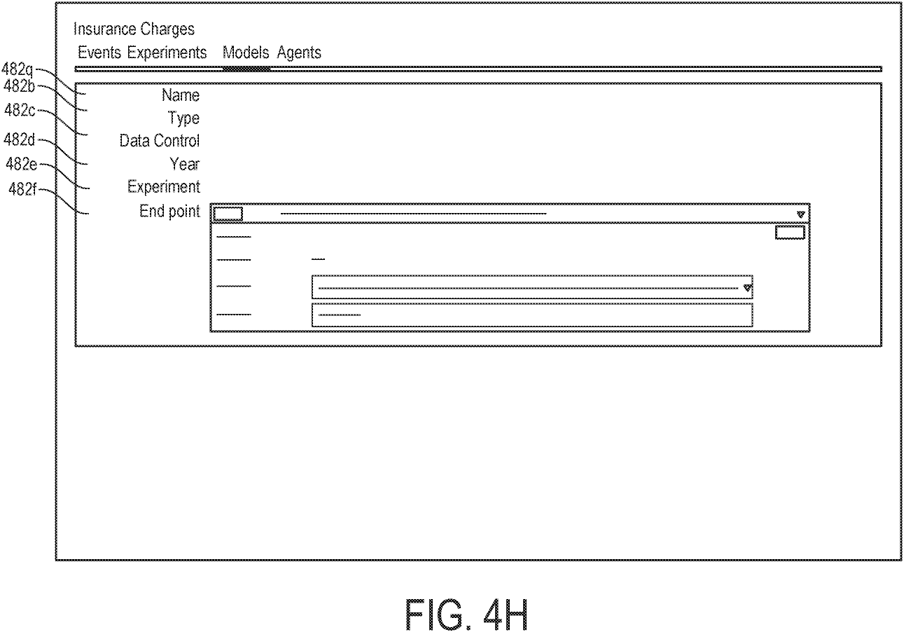

Based on the output of machine learning operations, the analytics platform 110 can generate explainability statistics, at 216. The explainability statistics can include key performance indicators (KPIs) for model performance (e.g., goodness-of-fit measures, goodness-of-prediction measures, accuracy measures, precision measures, recall measures). For example, FIG. 4B shows a feature importance chart for a particular experiment performed by an AI/ML model. The analytics platform can include simplified navigation controls, such as hyperlinks, tabs, toggles, and so forth, that allow a user to easily navigate between the explainability statistics, feature definitions, and input definitions, which allows the feature definitions and/or models to be modified at run-time in order to improve model performance.

In some implementations, the model can be fine-tuned without re-importing the input data. For instance, the input data can be stored in a data store 130 of the analytics platform 110 and/or in cache memory of the analytics platform 110 in order to improve performance of the analytics application 150 as the user fine-tunes the feature definitions and iterates through the models.

### Example Components of the Analytics Platform

FIG. 3A is a block diagram showing example components of a graphical user interface (GUI) 300 in the analytics platform 110, in accordance with some implementations of the present technology. The GUI 300 enables a user (e.g., data scientist) to access, utilize and control various components of the analytics platform 110 (e.g., via the analytics application 150). As a general overview, the GUI 300 can include any suitable number of manager executables 360. According to various implementations, manager executables 360 can, together, comprise at least a part of the analytics application 150, and can enable user access and control particular components of the analytics platform 110, such as the data acquisition engine 112, feature engineering engine 114, AI/ML modeling engine 116, recommendation engine 118, feature catalogue 120, data store 130, model store 140 or another component. To that end, manager executables 360 can include computer-executable code, libraries, scripts, metadata, reference files, graphics, animations, and/or other suitable components structured to enable user interaction with the analytics platform 110.

As shown according to a non-limiting example, manager executables 360 can be implemented as a dataset manager 352, a project manager 354, an experiment manager 356, and/or a model manager 358.

The dataset manager 352 enables user access and control of various operations of the data acquisition engine 112. These operations, discussed further with respect to FIGS. 3B-3E, can include data ingestion operations, entity resolution operations, and/or match and merge operations.

The project manager 354 enables user access and control of data analytics projects, including version tracking, project task lists, and so forth. A particular data analytics project can encompass dataset operations (e.g., data ingestion), experiments (e.g., execution of specific machine learning models on the ingested data, score generation, recommendation generation), and/or data output operations (e.g., file generation, alert generation, dashboard generation). In some implementations, the project manager 354 includes and/or provides a command-line or GUI editor for generating one or more configuration files (e.g., YAML, XML, JSON), which can store configuration parameters for various experiments, datasets, AI/ML models, visualizers, and so forth. The configuration parameters can include dataset reference identifiers (e.g., table names), SQL code for joining particular datasets and performing other feature engineering operations, feature definitions, threshold information, model-specific parameters, location information, hyperlink information, indications of source directories for training data, indications of source directories for experiment data, and so forth. At runtime, a particular experiment or model can reference one or more configuration files to determine the appropriate settings.

The experiment manager 356 enables user access and control of various operations of the feature engineering engine 114. These operations can include feature management operations, such as creation of features, feature storage, feature versioning, and so forth. In some implementations, the experiment manager 356 includes a tokenizer, which can operate on unstructured data to normalize text, extract and/or generate tokens based on the text, determine keywords using the text, and so forth. In some implementations, the experiment manager 356 includes a GUI that allows users to encode string values, specify criteria for handling null values, aggregate features to create new features, join datasets, customize logic to create new features, detect and handle outliers, select features, delete or remove features, select and encode target columns, and so forth. In some implementations, the experiment manager 356 includes a configuration file generator structured to generate a definition file for a particular feature or set of features (e.g., YAML) and save the file in a feature registry, such as the feature catalogue 120, data store 130, and/or model store 140. In some implementations, the experiment manager 356 includes a plurality of engines (e.g., Snowflake, Python, PySpark) that can be used to create feature sets for model development. The experiment manager 356 can include a GUI control that allows a user to select a particular engine to perform data processing and/or transformation operations. In some implementations, the experiment manager 356 includes a feature lineage tracker and/or feature lineage analytics.

The model manager 358 enables user access and control of various operations of the AI/ML modeling engine 116 and/or recommendation engine 118. These operations can include classification operations, regression operations, image processing operations, video analysis operations, natural language processing (NLP) operations, forecasting time series operations, and so forth. In some implementations, definition and/or configuration information for the machine learning models can be stored in the model store 140. The model manager 358 can enable various model-specific operations, including, for example, model design, model training, model deployment, model optimization, endpoint deployment, and/or endpoint monitoring. In some implementations, the model manager 358 can include datasets, event listeners, executables, and/or GUIs to facilitate model quality assurance. For example, the model manager 358 can include a data store that specifies and stores the definitions for key performance indicators (KPIs) for model performance (e.g., goodness-of-fit measures, goodness-of-prediction measures, accuracy measures, precision measures, recall measures), business KPIs, compliance KPIs, approval flows, and so forth. When a model is deployed for inclusion in the model store 140, an event listener can detect the deployment attempt and initiate one or more in a series of model quality assurance checks using the KPI definitions. Once a predetermined number of checks is passed and/or once a predetermined number of approvals for a model has been received and recorded, the model manager can generate an endpoint, such as a secure hyperlink (e.g., HTTPS) that provides an interface for client devices to execute the model and receive results.

FIGS. 3B-4H show examples of GUIs associated with the analytics application 150. In some implementations, the navigation schema for navigating among the GUIs is structured according to FIG. 3A, allowing the user (e.g., data scientist) to perform activities associated with different points in the feature engineering lifecycle from a single screen (e.g., by navigating using different tabs, hyperlinks, and so forth).

FIGS. 3B-3E are block diagrams showing example GUIs for the data acquisition and feature engineering engines (112, 114) of the analytics platform 110 in accordance with some implementations of the present technology. Utilizing these GUIs, users can specify platform instructions to encode string values, handle null values, aggregate features to create new features, join multiple datasets, create new features, detect and handle outliers, select features, drop features, select and encode target columns, and so forth.

Using a patient readmission analytics use case as an example, the GUI of FIG. 3B enables a user to import 362 a dataset or select a pre-built data source connector in order to acquire input data. A particular data source connector can include a system identifier 366, database identifier 368, date 370 (e.g., creation date, last update date), host identifier 372, and/or port number 374. The user can enter or modify these values, which causes the platform to generate a connection string for a particular input data source. FIG. 3C shows an example front end to the feature catalogue 120. The items in the feature catalogue 120 can include a feature identifier 378, a data source 380, a data source type 382, and a feature description 384. The user can perform attribute mapping operations, entity resolution operations, and so forth to match the fields in the input data to the fields in the previously defined features. After these operations are performed, the platform can generate a GUI shown in FIG. 3D. The GUI of FIG. 3D can include connectivity information 390, summary panel 386, and a detail panel 388. The connectivity information 390 can include input dataset connectivity information and/or data analytics engine information (e.g., a data analytics tool associated with the analytics application 150, such as Snowflake, SQL Server, or another suitable tool). In some implementations, the user is enabled to select a particular analytics engine to perform one or more of the feature engineering operations described herein. For example, in response to detecting a user selection of an analytics engine, the platform can invoke an executable associated with the selected engine to perform data analytics operations and generate the summary panel 386 and/or detail data 388. As shown, design of the GUI of FIG. 3D enables the summary panel 386 to be displayed alongside detail data 388, which preserves the space on small screen. In some implementations, to take advantage of vertical scrolling functionality using a scroll bar, the summary panel 386 is disposed on top of the detail panel 388 and can be locked to remain visible as the user scrolls through the detail data. In some implementations, the summary panel 386 includes summary graphics that visualize data points in the detail panel 388.

FIG. 3E shows an example feature lineage browser 392 where features 393b are tracked relationally to datasets 393a. The feature lineage browser 392 is structured to enable the technical advantage of resolving, in a single-screen visualization, the many-to-many relationship between features and datasets, where ordinarily feature/dataset relationship may be difficult to track because a feature can be used in multiple datasets and a dataset can be used with many features. As shown, the feature lineage browser 392 includes a hierarchical and/or linked structure that includes a plurality of nodes. When a user interacts with a particular node (e.g., in set of datasets 393a), a detail grid 394 can be displayed alongside the feature lineage browser 392. The detail grid 394 can include, for a particular input dataset or a view (e.g., multiple datasets joined together), feature definitions, including, for example, feature order 396a, feature identifier 396b, operator value 396c, feature code execution instructions 396d, and/or active flag 396e. Without having to navigate to a different screen, the user can explore a particular feature 393b and see datasets where the feature was used. Accordingly, the user can browse feature lineage by dataset or by feature.

FIGS. 4A-4D are diagrams showing example model explainability GUIs for the feature engineering engine 114 of the analytics platform 110 in accordance with some implementations of the present technology. Model explainability executables on the platform 110 are structured to perform operations that allow users to understand and interpret the predictions made by machine learning models. Outputs of the model explainability executables can help users identify the factors that influence a specific prediction, as well as assess the performance and accuracy of the model. In some implementations, the executables implement the SHAP (Shapley Additive Explanations) algorithm by computing and visualizing SHAP values and decision trees, thereby providing information regarding the strengths and weaknesses of the model and enabling users to make informed decisions and take appropriate actions to improve model performance.

FIG. 4A visualizes local interpretation features of the analytics platform 110. In an example implementation, the SHAP algorithm is used. SHAP provides explanations for individual predictions made by a particular machine learning model. The aim of SHAP is to provide consistent way to attribute the prediction of a model to the input features. SHAP shows the impact of each feature by interpreting the impact of a certain value compared to a baseline value. The baseline used for prediction is the average of all the predictions. SHAP values allow uses to determine any prediction as a sum of the effects of each feature value. A positive SHAP value means that a feature is contributing to a higher prediction, while a negative SHAP value means that the feature is contributing to a lower prediction.

As shown, a reference experiment 402 is a binary classification use case predicting whether a customer can be retained. The target variable is PROBABILITY_OF_CANCELLATION, encoded as 1 (will cancel) or 0 (will not cancel). The interpretation data set 410 shows that the calculated prediction probability of the model is 0.42, showing that a customer likely will not cancel relative to a user-selected threshold of 0.5. The prediction is generated for a sample record where the complaint count 412 is set to 1. The feature MAXIMUM_DAYS_FOR_RESOLUTION is shown to have the highest predictive value.

FIG. 4B visualizes global interpretation features of the analytics platform 110, such as feature importance. Global interpretation features help determine how the model makes decisions for all data points. Feature importance is a measure of the relative influence of each feature on the predictions made by a machine learning model calculated as a metric, such as mean decrease impurity or mean decrease accuracy, which quantifies the impact of a feature on the overall performance of the model. Feature importance can be used in feature selection to help identify the most significant features that should be included in the model, and to remove less significant features that can be redundant or noisy and have a relative lower explanatory value. Feature importance is also useful for model interpretability, as this metric provides a way to understand which features are driving the predictions made by the model. As shown in the feature importance plot 420, different variables have different levels of feature importance in a particular experiment, with PURCHASE_HABITS_OTHERS being of the highest relative importance.

FIG. 4C visualizes global interpretation features of the analytics platform 110, such as partial dependence plots (PDPs). PDPs are a type of visualization tool that helps to explain the behavior of a machine learning model. They are used to understand how a feature affects the predictions made by a model, while holding all other features constant. PDPs, such as the PDP 434, show relationships between the target variable and a feature. Such a relationship could be complex, monotonic, or even a simple linear one. PDPs can help identify significant features, as well as detect potential biases, outliers, or anomalies in the data. PDPs can also be used to validate the assumptions made by the model, and to detect the presence of confounding variables that may be affecting the relationship between the features and the prediction. As shown according to an example, as the number of escalated complaints 432 increases (X-axis), the probability of cancellation also increases (Y-axis).

FIG. 4D visualizes global interpretation features of the analytics platform 110, such as decision trees. An example decision tree 440 is shown for PROBABILITY_OF_CANCELLATION as a target variable. Decision trees, such as the decision tree 440, are a type of machine learning model that can be used for both prediction and model explainability. They make predictions by sequentially splitting the data into smaller and smaller groups based on the values of the features. The tree structure of a decision tree 440 provides a representation of the relationships between the features and the target variable. For example, if a decision tree is used to predict whether a customer will purchase a product, the tree structure will show the conditions that lead to a positive or negative prediction, such as the customer’s income or the product’s price. In addition to being a predictive model, decision trees can also be used as an explainability tool, as they provide a visual representation of the factors that influence the predictions made by the model. As shown, the leaf nodes 442 in the example decision tree 440 are part of a node-by-node visualization along a predicted decision path.

FIGS. 4E-4H are diagrams showing additional example GUIs for the AI/ML modeling engine 116 of the analytics platform in accordance with some implementations of the present technology. In some implementations, a user (e.g., data scientist) can specify a model to use. For example, when using classification, the user can select an executable for a particular model, such as random forest, logistic regression, XGBoost, LightGBM, and so forth. Deep learning models, such as Pytorch and/or Keras, can also be executed. In some implementations, the analytics platform 110 can execute multiple models and automatically select the model or models with the highest predictive value by comparing predictive values. To assess model performance and predictive values, as shown in FIG. 4E, the analytics platform 110 can compute/generate and visualize the validation scores (454c-e), a confusion matrix 456, feature importance values and so forth. As shown in FIG. 4F, the user can execute one or more deep learning models 462. The model customization interface allows the user to customize model parameters at runtime. The customized parameters can include the number of layers, learning rate, optimizer, activation function, and/or number of epochs. The visualizer 466 can compute/generate and visualize the R-squared scores per epoch, according to an example implementation. In some implementations, the analytics platform 110 can generate models that include modified parameter sets relative to the base model. As shown in FIG. 4G, the analytics platform can generate a visualizer for a model execution path 476 and a model legend 472, which can allow the user to set the parameters (e.g., weight, support vector, coefficient) and/or hyperparameters (e.g., learning rate, number of iterations) for the model.

FIG. 4H shows an example model deployment GUI, which can include a model name 482a, type 482b, data control 482c, year 482d, experiment 482e, and end point path 482f. The endpoint path can include a URL that encodes a secure hyperlink (e.g., using the HTTPS or another suitable protocol).

### Example Use Cases of the Analytics Platform

FIGS. 5A and 5B are diagrams illustrating example use cases of the analytics platform 110 in accordance with some implementations of the present technology. One of skill will appreciate that the technology described herein (e.g., the analytics platform 110) can support a variety of use cases across various industries, such as healthcare, insurance, business operations, consumer goods, industrial operations, building operations, and/or the like. Furthermore, one of skill will appreciate that the technology described herein (e.g., the analytics platform 110) can support a variety analytical AL/ML based operations across different knowledge domains, such as sales, marketing, insurance policy, healthcare operations, product analytics, activity analytics, customer interaction analytics, life event analytics, actuarial operations, IoT device operations, industrial/plant operations, and/or control of physical and/or virtual systems. Accordingly, the use cases are discussed herein for illustrative purposes to highlight some aspects of operation of the analytics platform 110 in a non-exhaustive fashion.

According to the use cases of FIGS. 5A and 5B, a business entity, such as an insurance company, can engage a plurality of agents. Each agent can be responsible for evaluating a business or individual customer’s needs and financial status and proposing insurance plans that meet customer criteria. Each agent can, further, be responsible for identifying prospective customers and maintaining communications with prospective customers via various communication channels, such as by mail, phone, email, and/or text.

FIG. 5A shows an example use case for explanatory variable detection using classification modeling on transformed data that includes features generated by the analytics platform 110. As shown in FIG. 5A, agent effectiveness can be evaluated according to metrics 512, which can be determined by the analytics platform 110. For instance, a user of the analytics platform 110 (e.g., a data scientist) may start with an agent dataset, which can include agent demographic information, agent sales statistics, and the like, and a policy dataset, which can include policy-specific information (e.g., issuer identifier, terms, interest rate, coverage amount, premium amount, withdrawal terms, guaranteed period information). The user of the analytics platform 110 may seek to answer various performance related questions, such as: “Who is the right agent [502] to sell our product?”, “What are the attributes [504] that drive successful agent behavior?”, and/or “What kind of products [506] do successful agents sell?” The analytics platform 110 can ingest the agent dataset automatically (e.g., via an interface, batch file download process) or at the direction of the user (e.g., via a GUI associated with the dataset manager 352). The ingested data can be transformed to standardize data (e.g., according to the feature catalogue 120), eliminate null values, extract segments or tokens from data, concatenate segments or tokens from data, and so forth. Using multi-year annuities as an example, the ingested data can be transformed to determine periodic payout amounts in a particular future time period for each policy that covers the time period, determine the present value of expected future periodic payments on each particular policy that covers the time period (e.g., based on the policy term, based on whether a lifetime rider was purchased by the insured), determine total anticipated agent commission and/or other policy costs to the insurance company, and so forth. Accordingly, transforming data using feature engineering allows for agent effectiveness to be evaluated based on nuanced metrics, such as expected return on each policy sold by the agent, agent-specific compensation structure, and so forth.

The analytics platform 110 can execute experiment manager 356 and/or model manager 358 to perform analytical AI/ML operations on the transformed data. The analytical AI/ML operations can include, for example, a segmentation model 505 and/or a clustering model 510. The model can be pre-trained using reference data and/or historical data to generate agent performance evaluation scores, predictor scores, and so forth. For instance, the model can receive a set of input features using the transformed agent data and generate propensity-to-sell scores (e.g., in a range, such as 1 to 100, 0.0001 to 1.0000) for each agent. The agent records can be segmented according to a threshold 507, which can be a numerical threshold value relating to a percentile rank or the propensity-to-sell score. In some implementations, the user can change the threshold in real time as the model is executed to fine-tune the model. One or more explanatory features 509 can be identified (e.g., by determining a Gini coefficient or by using another suitable importance measure) from a plurality of input features in the transformed dataset to be most likely to explain or contribute to the propensity-to-sell score. In some implementations, the user can add or remove items from the set of explanatory features 509 in real time as the model is executed to fine-tune the model. Additionally or alternatively, the agent records can be clustered according to value ranges and/or value categories in the one or more explanatory features 509.

FIG. 5B shows an example use case for probabilistic analytics on transformed data that includes features generated by the analytics platform 110. For the purpose of the use case in FIG. 5B, client conversion rate can be thought of as a ratio of customers who buy a product (e.g., an annuity, an insurance policy) to the number of customers exposed to information about the product via various channels, such as rate communication, call, email, meeting, webinar, and so on. Different communication paths 525 can each include sequences of touchpoints via one or more of the channels. For example, a call to a client can be followed by an educational webinar. Communication paths 525 can have conversion probabilities 527.

As shown in FIG. 5B, effectiveness of touchpoint activities can be evaluated by sequencing activities into various paths 534 and determining the optimal path(s) by the analytics platform 110. For instance, a user of the analytics platform 110 (e.g., a data scientist) may start with an interaction dataset, which can include a log of various client touchpoints. The log can include information such as target customer identifier, type of touchpoint (rate communication, call, email, meeting, webinar), date, start time, end time, duration, and so forth. The user of the analytics platform 110 may seek to answer various touchpoint related questions, such as: “What is the best path [522] for conversion?”, “What is the next best touchpoint [524] for conversion after a particular touchpoint?”, and/or “What is the optimal number of times [526] an agent should reach out to a target customer?” The analytics platform 110 can ingest the dataset automatically (e.g., via an interface, batch file download process) or at the direction of the user (e.g., via a GUI associated with the dataset manager 352). The ingested data can be transformed to standardize data (e.g., according to the feature catalogue 120), eliminate null values, extract segments or tokens from data, concatenate segments or tokens from data, and so forth. Using customer interaction logs as an example, the ingested data can be transformed to determine a type of touchpoint based on contextual information (e.g., activity address, activity web link). For instance, a customer interaction log can include a data feed from a scheduling platform, case docketing platform, appointment tracking platform, and/or the like, and the text and/or location fields of a particular appointment can be used to parse a proxy value. The proxy value can be used to infer a type of meeting. For instance, an address can indicate that the meeting was in-person, a token parsed from a URL can indicate, by referencing a videoconferencing platform, that the meeting was via videoconference and/or that the activity related to a webinar, and so forth. As another example, the ingested data can be transformed to parse prospective customer’s identifying information from the log (e.g., name, email address, phone number) and cross-link the identifying information to a customer data store to determine if the prospective customer later purchased a product (i.e. that a conversion took place). Accordingly, transforming data using feature engineering (e.g., by joining separate interaction logs and customer datasets) allows for the effectiveness levels of touchpoint activities to be evaluated more precisely. Furthermore, transforming data using feature engineering by cross-referencing existing data can reduce the file size and, accordingly, the number of read/write operations at the point the data is ingested by the analytics platform 110.

The analytics platform 110 can execute the experiment manager 356 and/or model manager 358 to perform analytical AI/ML operations on the transformed data. The analytical AI/ML operations can include, for example, a Markov chain simulation model 530. The model can be pre-trained using reference data and/or historical data to generate touchpoint sequence recommendations, next best activity recommendations, optimal number of touchpoints, and so forth. For instance, the model can receive a set of input features using the transformed interaction log data and generate probability-of-conversion scores (e.g., in a range, such as 1 to 100, 0.0001 to 1.0000) for various observed and/or simulated paths (sequences of touchpoints). The generated paths can be segmented according to a probability threshold, which can be a numerical threshold value relating to the calculated probability of conversion, and touchpoint sequence recommendations and/or optimal number of touchpoints can be determined for paths 534 that meet or exceed the threshold. In some implementations, the user can change the threshold in real time as the model is executed to fine-tune the model. In some implementations, the model can generate, for a particular activity on a path, a next best activity 536 recommendation by calculating conversion probabilities for pairs of nodes (interaction activities) on a particular path. For example, the model can access reference data regarding a segment of the path that precedes the pair of nodes, determine a conversion probability for the segment based on a reference probability, and account for the conversion probability for the segment when generating a conversion probability value for the pair of nodes. For instance, if ordinarily a conversion probability of an email followed by a call is 0.5, but the email was preceded by a rate inquiry from the customer, the rate inquiry can indicate a greater interest in buying and can therefore increase the probability value for an email followed by a call in a particular interaction.

According to various use cases, the analytics platform 110 can be utilized in a variety of ways, including combining and expanding on aspects of the use cases described above. For instance, the analytics platform 110 can score various aspects of agent performance, product performance, customer satisfaction, customer or agent profitability, customer experience, and so forth. In some use cases, agent persona optimization can be performed by linking a set of agents to a set of customers. For instance, based on the outputs of the feature engineering operations, the analytics platform 110 can identify agents that have particular attributes, such as geography, customer base, and so forth. Customers in the customer base can be analyzed to generate a product interest score (e.g., by determining a probability that an existing customer will be interested in a particular product given a customer relationship with an existing product). Agents can be matched to customers based on geography and/or customer product interest scores.

### Example Computer Systems

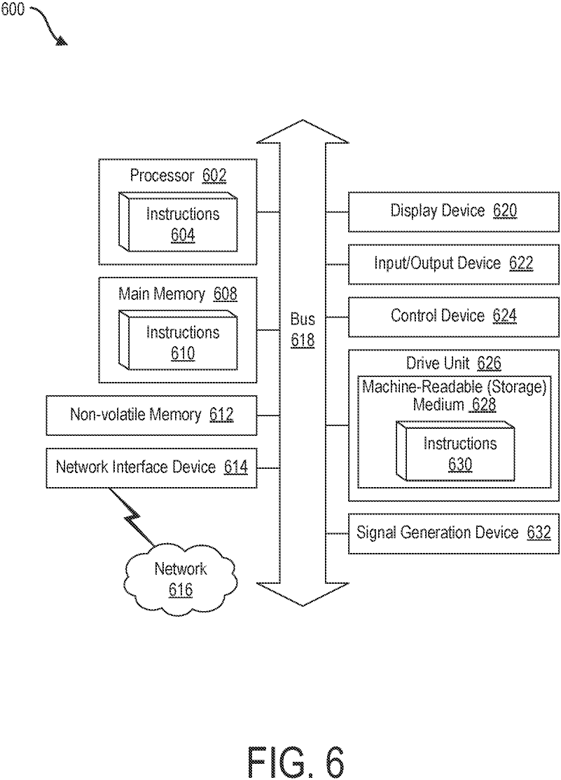

FIG. 6 is a block diagram showing some of the components typically incorporated in at least some of the computer systems and other devices 600 on which the disclosed system operates in accordance with some implementations of the present technology. As shown, an example computer system 600 can include: one or more processors 602, main memory 608, non-volatile memory 610, a network interface device 614, video display device 620, an input/output device 622, a control device 624 (e.g., keyboard and pointing device), a drive unit 626 that includes a machine-readable medium 628, and a signal generation device 632 that are communicatively connected to a bus 618. The bus 618 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 600. In some implementations, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 614 enables the computer system 600 to exchange data in a network 616 with an entity that is external to the computing system 600 through any communication protocol supported by the computer system 600 and the external entity. Examples of the network interface device 614 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 608, non-volatile memory 612, machine-readable medium 628) can be local, remote, or distributed. Although shown as a single medium, the machine-readable medium 628 can include multiple media (e.g., a centralized/distributed database and/or associated caches and servers) that store one or more sets of instructions 630. The machine-readable (storage) medium 628 can include any medium that is capable of storing, encoding, or carrying a set of instructions for execution by the computer system. The machine-readable medium 628 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 610, 630) set at various times in various memory and storage devices in computing device(s). When read and executed by the processor 602, the instruction(s) cause the computer system 600 to perform operations to execute elements involving the various aspects of the disclosure.

### Example Computing Environment

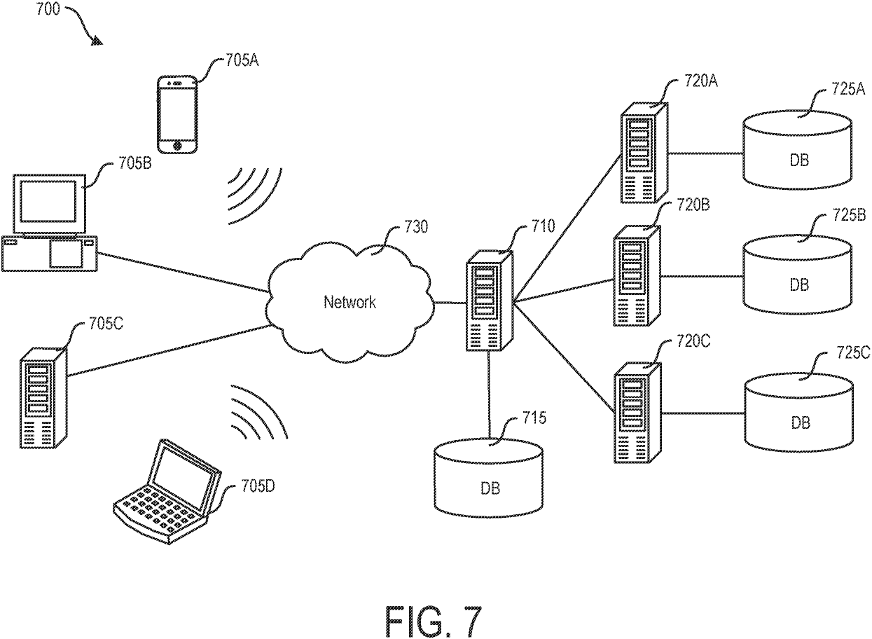

FIG. 7 is a system diagram illustrating an example of a computing environment in which the disclosed system operates in some implementations. In some implementations, environment 700 includes one or more client computing devices 705A-D, examples of which can host the system 600. Client computing devices 705A-D operate in a networked environment using logical connections through network 730 to one or more remote computers, such as a server computing device.

In some implementations, server 710 is an edge server which receives client requests and coordinates fulfillment of those requests through other servers, such as servers 720A-C. In some implementations, server computing devices 710 and 720 comprise computing systems, such as the system 600. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server or client devices. In some implementations, servers (710, 720A-C) connect to a corresponding database (715, 725A-C). As discussed above, each server 720 can correspond to a group of servers, and each of these servers can share a database or can have its own database. Databases 715 and 725 warehouse (e.g., store) information such as model data, feature data, configuration data, operational data, log data, calendar data, images, health records, insurance policy records, documents, books, journals, audio, video, metadata, analog data, and so on. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. In some implementations, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

We claim:

1. A computer-implemented method for feature engineering in an artificial intelligence/machine learning (AI/ML) computing system, the method comprising:
receiving, via a data acquisition engine of an analytics application provided to a subscriber computing device, an input dataset comprising data regarding operations of a subscriber entity;
generating, by a feature engineering engine of the analytics application, a reduced discovery dataset based on the input dataset and storing at least a portion of the reduced discovery dataset in cache memory associated with the analytics application;
while displaying, via a graphical user interface (GUI) associated with the analytics application, at least a portion of the reduced discovery dataset, performing feature engineering operations comprising:
performing, by the feature engineering engine, an entity resolution operation on the input dataset, comprising applying a first machine learning model to a set of items in the input dataset and a set of features retrieved from a feature catalogue to perform a match operation based on fuzzy logic; and
based on output of the match operation, generating an instantiated set of features by associatively storing the set of items in the input dataset to the set of features in the feature catalogue;
using the instantiated set of features, applying a second trained machine learning model to generate a recommendation, wherein the second trained machine learning model is automatically selected from a plurality of models based on a performance metric determined for the instantiated set of features;
providing a visual indication of the generated recommendation via the GUI; and
generating or updating a feature definition mark-up file, wherein the feature definition mark-up file comprises at least two of:
a feature identifier,
a feature configuration parameter,
a SQL query, or
feature versioning information.

2. The method of claim 1, wherein the analytics application is provided by a provider entity associated with the AI/ML computing system, and wherein the analytics application is on a virtual network associated with the subscriber entity.

3. The method of claim 1, further comprising generating the reduced discovery dataset using random sampling.

4. The method of claim 1, further comprising generating the reduced discovery dataset using stratified sampling.

5. The method of claim 1, wherein a size of the reduced discovery dataset is optimized by performing at least one of:
generating the reduced discovery dataset to be at or under a predetermined size limit,
extracting a predetermined number of records from the input dataset, or
extracting a predetermined percentage of records from the input dataset.

6. The method of claim 1, wherein performing the entity resolution operations comprises de-duplicating an item in the input dataset.

7. The method of claim 1, wherein performing feature engineering operations further comprises:
providing, via the GUI, an analytics engine selection control; and
responsive to detecting a selection using the analytics engine selection control, invoking an executable associated with the selected analytics engine to perform operations comprising:
generating a visual summary of an item in the instantiated set of features; and
causing the GUI to display the visual summary along with the instantiated set of features.

8. The method of claim 7, wherein the item is a derived item, and wherein the visual summary relates to a local explainability statistic for the item.

9. The method of claim 7, wherein the visual summary relates to a global explainability statistic for at least a subset of the instantiated set of features.

10. The method of claim 9, further comprising generating and displaying a GUI control structured to enable a modification of a threshold relating to the global explainability statistic.

11. The method of claim 1, wherein the recommendation comprises at least one of: a score, a probability, a discovered cluster, or a data visualization.

12. The method of claim 1, wherein the input dataset is indicative of one or more activities, and wherein generating the recommendation comprises determining a next best activity for an activity in a set of one or more activities.

13. The method of claim 1, further comprising:
generating and displaying a visual summary of the instantiated set of features, wherein the instantiated set of features is shown as a linking item between a first node in a first set of nodes, the first node indicative of the input dataset, and a second node in a second set of nodes, the second node indicative of the set of features.

14. The method of claim 13, further comprising:
upon detecting a user interaction with the linking item, generating and displaying, along with the visual summary, a detail record for a particular feature associated with the linking item, wherein the detail record includes at least one of:
a project identifier for a project that includes the instantiated feature,
an instantiated feature identifier,
an instantiated feature configuration parameter,
a SQL query associated with the instantiated feature, or
feature versioning information.

15. The method of claim 1, wherein the feature definition mark-up file is a first feature definition mark-up file, wherein performing the feature engineering operations further comprises:
determining the set of features in the feature catalogue based on a previously generated second feature definition mark-up file.

16. A computer-implemented method for determining a next best activity for an agent associated with a subscriber entity using feature engineering in an artificial intelligence/machine learning (AI/ML) computing system, the method comprising:
receiving, via a data acquisition engine of an analytics application provided to a subscriber computing device, an activity dataset comprising data regarding operations of the agent;
generating, by a feature engineering engine of the analytics application, a reduced discovery dataset based on the activity dataset;
while displaying, via a graphical user interface (GUI) associated with the analytics application, at least a portion of the reduced discovery dataset, performing feature engineering operations comprising:
performing, by the feature engineering engine, an entity resolution operation on the activity dataset;
based on a feature configuration file, determining a feature catalogue to reference; and
generating an instantiated set of features by associatively storing a set of activities in the activity dataset to a set of features in the feature catalogue;
using the instantiated set of features, applying a second trained machine learning model to determine a next best activity for an activity in the set of activities; and
providing a visual indication of the determined next best activity via the GUI.

17. The method of claim 16, further comprising:
generating a plurality of customer conversion communication paths; and
using the plurality of customer conversion communication paths, determining the next best activity.

18. The method of claim 16, wherein the analytics application is provided by a provider entity associated with the AI/ML computing system, and wherein the analytics application is on a virtual network associated with the subscriber entity.

19. One or more computer-readable media having computer-executable instructions stored thereon, the instructions, when executed by at least one processor of an artificial intelligence/machine learning (AI/ML) computing system, causing the at least one processor to perform operations for feature engineering, the operations comprising:
receiving, via a data acquisition engine of an analytics application provided to a subscriber computing device, an input dataset comprising data regarding operations of a subscriber entity;
generating, by a feature engineering engine of the analytics application, a reduced discovery dataset based on the input dataset and storing at least a portion of the reduced discovery dataset in cache memory associated with the analytics application;
while displaying, via a graphical user interface (GUI) associated with the analytics application, at least a portion of the reduced discovery dataset, performing feature engineering operations comprising:
performing, by the feature engineering engine, an entity resolution operation on the input dataset, comprising applying a first machine learning model to a set of items in the input dataset and a set of features retrieved from a feature catalogue to perform a match operation based on fuzzy logic; and
based on output of the match operation, generating an instantiated set of features by associatively storing the set of items in the input dataset to the set of features in the feature catalogue;
using the instantiated set of features, applying a second trained machine learning model to generate a recommendation, wherein the second trained machine learning model is automatically selected from a plurality of models based on a performance metric determined for the instantiated set of features; and
providing a visual indication of the generated recommendation via the GUI.

20. The media of claim 19, the operations further comprising:
generating and displaying a visual summary of the instantiated set of features, wherein the instantiated set of features is shown as a linking item between a first node in a first set of nodes, the first node indicative of the input dataset, and a second node in a second set of nodes, the second node indicative of the set of features; and
upon detecting a user interaction with the linking item, generating and displaying, along with the visual summary, a detail record for a particular feature associated with the linking item, wherein the detail record includes at least one of:
a project identifier for a project that includes the instantiated feature,
an instantiated feature identifier,
an instantiated feature configuration parameter,
a SQL query associated with the instantiated feature, or
feature versioning information.
